(19) United States
(12) Patent Application Publication
(10) Pub. No.: US 2008/0254904 A1
(43) Pub. Date: Oct. 16, 2008

(54) VEHICLE DRIVE SHAFT

(75) Inventor: Tomoatsu IWASA, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/100,095

(22) Filed: Apr. 9, 2008

(30) Foreign Application Priority Data
Apr. 10, 2007 (JP) 2007-102839

(51) Int. Cl. F16D 3/20; F16C 3/02

(52) U.S. Cl. 464/162; 464/167

(57) ABSTRACT

A vehicle drive shaft is disclosed that includes a sliding type constant velocity joint, a shaft member, a boot, and an insolating member. The sliding type constant velocity joint includes an outer ring having an accommodation chamber, and an inner ring accommodated in the accommodation chamber. The isolating member forms a pressure relaxation chamber in the outer ring so as to isolate the pressure relaxation chamber and the accommodation chamber from each other. When the pressure in the accommodation chamber is raised, the isolating member is displaced toward the pressure relaxation chamber by a pressure difference between the accommodation chamber and the pressure relaxation chamber, thereby increasing the volume of the accommodation chamber. When the pressure in the accommodation chamber is lowered, the isolating member is displaced toward the accommodation chamber by the pressure difference, thereby decreasing the volume of the accommodation chamber.

### BACKGROUND OF THE INVENTION

The present invention relates to a drive shaft for transmitting driving force to drive wheels of a vehicle.

For example, Japanese Laid-Open Patent Publication No. 8-80704 discloses a drive shaft used in a vehicle. FIG. 7 illustrates one such drive shaft. As shown in FIG. 7, one end 110a of a shaft member 110 is coupled to a hub 102 of a drive wheel through a Birfield type constant velocity joint 120. The other end 110b is coupled to a differential gear 103 through a sliding type tripod constant velocity joint 130.

The Birfield type constant velocity joint 120 includes an inner ring 121 fitted to the end 110a of the shaft member 110 and an outer ring 122, in which an accommodation chamber 141 is formed. The inner ring 121 is accommodated in the accommodation chamber 141. The outer ring 122 has a rod portion 125 extending in the axial direction. The rod portion 125 is attached to an attachment hole 102a formed in the hub 102. More specifically, a spline extending in the axial direction is formed on the outer circumferential surface of the rod portion 125, and a spline corresponding to the spline of the rod portion 125 is formed on the inner circumferential surface of the attachment hole 102a. The rod portion 125 is inserted to the attachment hole 102a with the splines engaged with each other.

A substantially cylindrical cage 124 and a plurality of balls 123 (only one is shown in FIG. 7) are provided between the inner ring 121 and the outer ring 122. Each ball 123 is fitted in one of a plurality of retaining holes 124a formed in the cage 124. Pairs of guide grooves 121a, 122a are formed in the outer circumferential surface of the inner ring 121 and the inner circumferential surface of the outer ring 122, respectively. The grooves 121a, 122a extend along the axial direction of the inner ring 121 and the outer ring 122. Each pair of the guide grooves 121a, 122a correspond to one of the balls 123. Each retaining hole 124a of the cage 124 supports one of the balls 123, which is fitted in the corresponding pair of the guide grooves 121a, 122a. This structure allows precession of the outer ring 122 and the hub 102 about the end 110a of the shaft member 110 in a certain range, and on the other hand, restricts axial displacement relative to the shaft member 110. The shaft member 110 and the opening portion of the outer ring 122 is covered by an accordion-folded boot 126, which is made of, for example, rubber. A large diameter end (right end as viewed in the drawing) of the boot 126 is fastened to the outer circumference of the outer ring 122, and a small diameter end (left end as viewed in the drawing) is fastened to the outer circumference of the shaft member 110. This structure seals the accommodation chamber 141 of the outer ring 122. The accommodation chamber 141 is filled with grease, which lubricates components of the Birfield type constant velocity joint 120. The boot 126 prevents the grease from leaking.

The sliding type tripod constant velocity joint 130 includes an inner ring 131 fitted to the end 110b of the shaft member 110 and an outer ring 132, in which an accommodation chamber 142 is formed. The inner ring 131 is accommodated in the accommodation chamber 142 formed in the outer ring 132. The outer ring 132 has a rod portion 135 extending in the axial direction. The rod portion 135 is attached to an attachment hole 103a formed in the differential gear 103. More specifically, a spline extending in the axial direction is formed on the outer circumferential surface of the rod portion 135, and a spline corresponding to the spline of the rod portion 135 is formed on the inner circumferential surface of the attachment hole 103a. The rod portion 135 is inserted to the attachment hole 103a with the splines engaged with each other.

The inner ring 131 has three legs 131a (only one is shown in FIG. 7). A roller 133 is rotatably attached to each leg 131a. Three guide grooves 132a are formed in the inner circumferential surface of the outer ring 132. Each guide groove 132a corresponds to one of the three rollers 133. Each roller 133 is rollably guided by the corresponding guide groove 132a. This structure allows precession of the outer ring 132 about the end 110b of the shaft member 110 in a certain range, and allows axial displacement relative to the shaft member 110. The shaft member 110 and the opening portion of the outer ring 132 is covered by an accordion-folded boot 136, which is made of, for example, rubber. A large diameter end (left end as viewed in the drawing) of the boot 136 is fastened to the outer circumference of the outer ring 132, and a small diameter end (right end as viewed in the drawing) is fastened to the outer circumference of the shaft member 110. This structure seals the accommodation chamber 142 of the outer ring 132. The accommodation chamber 141 is filled with grease, which lubricates components of the sliding type tripod constant velocity joint 130. The boot 136 prevents the grease from leaking.

When the vehicle is moving, this type of power transmission mechanism allows the driving force of the internal combustion engine, which is supplied to the differential gear 103, to be transmitted to the hub 102, in the other words, to drive wheels, through the constant velocity joints 130, 120 and the shaft member 110.

The above described derive shaft is installed in a vehicle through the method shown below. That is, the rod portion 135 of the outer ring 132 of the sliding type tripod constant velocity joint 130 is assembled with the differential gear 103. Thereafter, the rod portion 125 of the outer ring 122 of the Birfield type constant velocity joint 120 is assembled with the hub 102, which is rotatably supported to the frame of the vehicle, for example, with a knuckle joint. A distance S1 between the openings of the attachment holes 102a, 103a in a state after the hub 102 and the differential gear 103 are mounted to the vehicle is shorter than a distance S2 between the ends of the rod portion 125, 135 in a state before the mounting. Therefore, after the sliding type tripod constant velocity joint 130 is assembled with the differential gear 103, a force in the axial direction of the shaft member 110 is applied to the outer ring 122 of the Birfield type constant velocity joint 120, so that, in a state where the shaft member 110 is slid along the direction represented by arrow L in FIG. 7 into the outer ring 132 of the sliding type tripod constant velocity joint 130, the rod portion 125 is moved to a position that corresponds to the attachment hole 102a. Then, the shaft member 110 is slid along a direction represented by arrow R shown in FIG. 7, so that the rod portion 125 is inserted into the attachment hole 102a.

When the shaft member 110 is slid into the outer ring 132 of the sliding type tripod constant velocity joint 130 as described above, the boot 136 is compressed. This reduces the volume of the space defined by the outer ring 132 and the boot 136, that is, the volume of the accommodation chamber 142 sealed by the boot 136. Accordingly, the internal pressure is increased. As a result, the resistance force of the shaft member 110 against sliding is increased. Therefore, when the rod portion 135 is attached to the attachment hole 103a, a relatively great force needs to be applied, which makes the installation troublesome. Particularly, in the case where a resin material is used instead of rubber for the boot 136 to increase the durability, the boot 136 is less susceptible to deformation. This further increases the resistance force of the shaft member 110 against sliding, which makes the installation further troublesome.

Although only the drive shaft having the sliding type tripod constant velocity joint 130 has been discussed, the above described drawback is not limited to the same construction, but in most cases common to any type of constant velocity joint that is attached to the shaft member 110 and can be moved in the axial direction relative to the shaft member 110. For example, the drawback may be found in a double offset type constant velocity joint.

### SUMMARY OF THE INVENTION

Accordingly, it is an objective of the present invention to prevent the installation of a drive shaft from being deteriorated due to a pressure increase in a space defined by an outer ring of a sliding type constant velocity joint and a boot.

To achieve the foregoing objective and in accordance with one aspect of the present invention, a vehicle drive shaft including a sliding type constant velocity joint, a shaft member, a boot, and an isolating member is provided. The sliding type constant velocity joint has an outer ring, in which an accommodation chamber is formed, and an inner ring accommodated in the accommodation chamber. The inner ring is permitted to be displaced in the axial direction relative to the outer ring, while being prevented from rotating relative to the outer ring. The shaft member has an end portion to which the inner ring is attached. The boot has one end fastened to the shaft member and another end fastened to an outer circumference of the outer ring. The boot seals the accommodation chamber and can be expanded and contracted in accordance with relative displacement of the outer ring and the shaft member. The isolating member forms a pressure relaxation chamber in the outer ring so as to isolate the pressure relaxation chamber and the accommodation chamber from each other. When a pressure in the accommodation chamber is raised, the isolating member is displaced toward the pressure relaxation chamber by a pressure difference between the accommodation chamber and the pressure relaxation chamber, thereby increasing the volume of the accommodation chamber. When the pressure in the accommodation chamber is lowered, the isolating member is displaced toward the accommodation chamber by the pressure difference, thereby decreasing the volume of the accommodation chamber.

In accordance with another aspect of the present invention, a vehicle drive shaft including a sliding type constant velocity joint, a shaft member, a boot, and an elastic film is provided. The sliding type constant velocity joint has an outer ring, in which an accommodation chamber is formed, and an inner ring accommodated in the accommodation chamber. The inner ring is permitted to be displaced in the axial direction relative to the outer ring, while being prevented from rotating relative to the outer ring. The shaft member has an end portion to which the inner ring is attached. The boot has one end fastened to the shaft member and another end fastened to an outer circumference of the outer ring. The boot seals the accommodation chamber and can be expanded and contracted in accordance with relative displacement of the outer ring and the shaft member. The elastic film forms a pressure relaxation chamber in the outer ring so as to isolate the pressure relaxation chamber and the accommodation chamber from each other. When a pressure in the accommodation chamber is raised, the elastic film is elastically deformed toward the pressure relaxation chamber by a pressure difference between the accommodation chamber and the pressure relaxation chamber, thereby increasing the volume of the accommodation chamber. When the pressure in the accommodation chamber is lowered, the elastic film is elastically deformed toward the accommodation chamber by the pressure difference, thereby decreasing the volume of the accommodation chamber.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view illustrating a vehicle drive shaft according to a first embodiment of the present invention;

FIG. 2 is a cross-sectional view illustrating the sliding type tripod constant velocity joint shown in FIG. 1, in which the boot is in a neutral state;

FIG. 3 is a cross-sectional view illustrating the sliding type tripod constant velocity joint shown in FIG. 1, in which the boot is in a compressed state;

FIG. 4 is a cross-sectional view illustrating a sliding type tripod constant velocity joint according to a second embodiment of the present invention, in which a boot is in a neutral state;

FIG. 5 is a cross-sectional view illustrating the sliding type tripod constant velocity joint according to the second embodiment, in which the boot is in a compressed state;

FIG. 6 is a cross-sectional view illustrating a pressure relaxation chamber according to a modification; and

FIG. 7 is a cross-sectional view illustrating a prior art vehicle drive shaft.

### DETAILED DESCRIPTION OF THE PREFERRED EMBODIMENTS

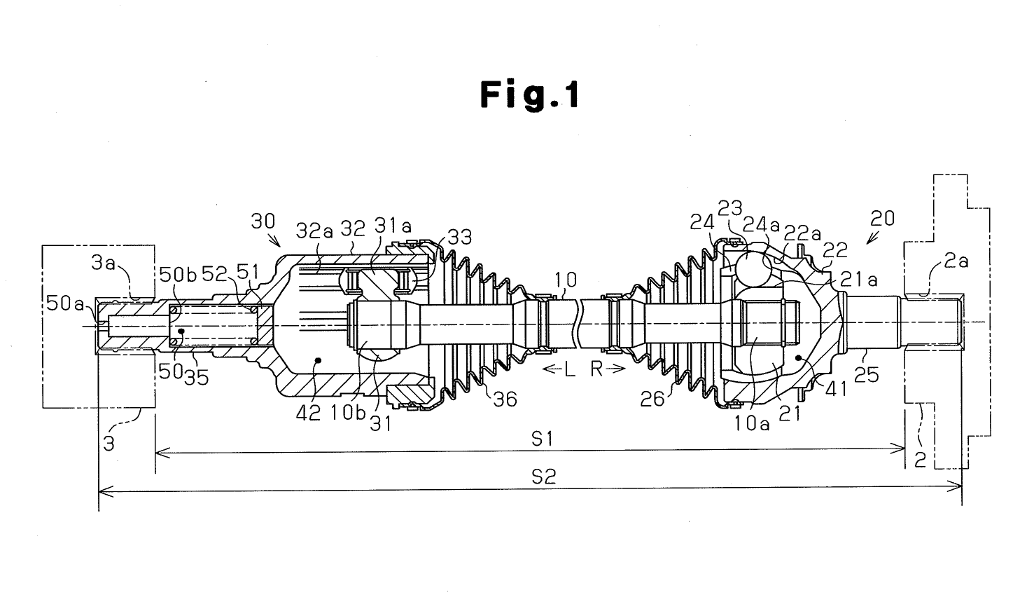

A vehicle drive shaft according to a first embodiment of the present invention will now be described with reference to FIGS. 1 to 3.

Like the drive shaft discussed in the prior art section, the drive shaft according to the present embodiment has a shaft member 10 having one end 10a coupled to a hub 2 of a drive wheel through a Birfield type constant velocity joint 20 as shown in FIG. 1. The other end 10b is coupled to a differential gear 3 through a sliding type tripod constant velocity joint 30. The differential gear 3 has a breather mechanism for substantially maintaining the internal pressure to the atmospheric pressure.

Like the prior art constant velocity joint 120 shown above, the Birfield type constant velocity joint 20 includes an inner ring 21 fitted to the end 10a of the shaft member 10 and an outer ring 22, in which an accommodation chamber 41 is formed. The inner ring 21 is accommodated in the accommodation chamber 41 formed in the outer ring 22. The outer ring 22 has a rod portion 25 extending in the axial direction. The rod portion 25 is attached to an attachment hole 2a formed in the hub 2. More specifically, a spline extending in the axial direction is formed on the outer circumferential surface of the rod portion 25, and a spline corresponding to the spline of the rod portion 25 is formed on the inner circumferential surface of the attachment hole 2a. The rod portion 25 is inserted to the attachment hole 2a with the splines engaged with each other.

A substantially cylindrical cage 24 and a plurality of balls 23 (only one is shown in FIG. 1) are provided between the inner ring 21 and the outer ring 22. Each ball 23 is fitted in one of a plurality of retaining holes 24a formed in the cage 24. Pairs of guide grooves 21a, 22a are formed in the outer circumferential surface of the inner ring 21 and the inner circumferential surface of the outer ring 22, respectively. The grooves 21a, 22a extend along the axial direction of the inner ring 21 and the outer ring 22. Each pair of the guide grooves 21a, 22a correspond to one of the balls 23. Each retaining hole 24a of the cage 24 supports one of the balls 23, which is fitted in the corresponding pair of the guide grooves 21a, 22a. This structure allows precession of the outer ring 22 and the hub 2 about the end 10a of the shaft member 10 in a certain range, and on the other hand, restricts axial displacement relative to the shaft member 10. The shaft member 10 and the opening portion of the outer ring 22 is covered by an accordion-folded boot 26, which is made of a resin material. A large diameter end (right end as viewed in the drawing) of the boot 26 is fastened to the outer circumference of the outer ring 22, and a small diameter end (left end as viewed in the drawing) is fastened to the outer circumference of the shaft member 10. This structure seals the accommodation chamber 41 of the outer ring 22. The accommodation chamber 41 is filled with grease, which lubricates components of the Birfield type constant velocity joint 20. The boot 26 prevents the grease from leaking.

The sliding type tripod constant velocity joint 30 includes an inner ring 31 fitted to the end 10b of the shaft member 10 and an outer ring 32, in which an accommodation chamber 42 is formed. The inner ring 31 is accommodated in the accommodation chamber 42 formed in the outer ring 32. The outer ring 32 has a rod portion 35 extending in the axial direction. The rod portion 35 is attached to an attachment hole 3a formed in the differential gear 3. More specifically, a spline extending in the axial direction is formed on the outer circumferential surface of the rod portion 35, and a spline corresponding to the spline of the rod portion 35 is formed on the inner circumferential surface of the attachment hole 3a. The rod portion 35 is inserted to the attachment hole 3a with the splines engaged with each other.

The inner ring 31 has three legs 31a (only one is shown in FIG. 1). A roller 33 is rotatably attached to each leg 31a. Three guide grooves 32a are formed in the inner circumferential surface of the outer ring 32. Each guide groove 32a corresponds to one of the three rollers 33. Each roller 33 is rollably guided by the corresponding guide groove 32a. This structure allows precession of the outer ring 32 about the end 10b of the shaft member 10 in a certain range, and allows axial displacement relative to the shaft member 10. The shaft member 10 and the opening portion of the outer ring 32 is covered by an accordion-folded boot 36, which is made of a resin material. A large diameter end (left end as viewed in the drawing) of the boot 36 is fastened to the outer circumference of the outer ring 32, and a small diameter end (right end as viewed in the drawing) is fastened to the outer circumference of the shaft member 10. This structure seals the accommodation chamber 42 of the outer ring 32. The accommodation chamber 41 is filled with grease, which lubricates components of the sliding type tripod constant velocity joint 30. The boot 36 prevents the grease from leaking.

When the vehicle is moving, this type of power transmission mechanism allows the driving force of the internal combustion engine, which is supplied to the differential gear 3, to be transmitted to the hub 2, in the other words, to drive wheels, through the constant velocity joints 30, 20 and the shaft member 10.

The above described drive shaft is installed in a vehicle through the method shown below. That is, the rod portion 35 of the outer ring 32 of the sliding type tripod constant velocity joint 30 is assembled with the differential gear 3. Thereafter, the rod portion 25 of the outer ring 22 of the Birfield type constant velocity joint 20 is assembled with the hub 2, which is rotatably supported to the frame of the vehicle, for example, with a knuckle joint. A distance S1 between the openings of the attachment holes 2a, 3a in a state after the hub 2 and the differential gear 3 are mounted to the vehicle is shorter than a distance S2 between the ends of the rod portion 25, 35 in a state before the mounting. Therefore, after the sliding type tripod constant velocity joint 30 is assembled with the differential gear 3, a force in the axial direction of the shaft member 10 is applied to the outer ring 22 of the Birfield type constant velocity joint 20, so that, in a state where the shaft member 10 is slid along the direction represented by arrow L in FIG. 1 into the outer ring 32 of the sliding type tripod constant velocity joint 30, the rod portion 25 is moved to a position that corresponds to the attachment hole 2a. Then, the shaft member 10 is slid along a direction represented by arrow R shown in FIG. 1, so that the rod portion 25 is inserted into the attachment hole 2a.

As described above, in the prior art drive shaft, when the shaft member 110 is slid into the outer ring 132 of the sliding type tripod constant velocity joint 130 as described above, the boot 136 is compressed. This reduces the volume of the space defined by the outer ring 132 and the boot 136, that is, the volume of the accommodation chamber 142 sealed by the boot 136. Accordingly, the internal pressure is increased. As a result, the resistance force of the shaft member 110 against sliding is increased. Therefore, when the rod portion 135 is attached to the attachment hole 103a, a relatively great force needs to be applied, which makes the installation troublesome. Particularly, in the case where a resin material is used for the boot 36 to increase the durability as in the present embodiment, the boot 36 is less likely to be deformed by a change in its internal pressure. This further increases the resistance force of the shaft member 10 against sliding, which makes the installation further troublesome.

Therefore, the drive shaft according to the present embodiment employs the configuration described below to facilitate the installation.

That is, a substantially cylindrical pressure relaxation chamber 50 is formed in the rod portion 35 of the outer ring 32. The pressure relaxation chamber 50 extends along the axial direction of the rod portion 35. The pressure relaxation chamber 50 is open to the accommodation chamber 42, and communicates with the outside of the outer ring 32 through a communication hole 50a. An isolating member 51 is provided in the pressure relaxation chamber 50. The isolating member 51 is slidable on the inner wall of the pressure relaxation chamber 50 along the axial direction. The isolating member 51 isolates the accommodation chamber 42 and the pressure relaxation chamber 50 from each other.

A spring (an urging member) 52 is arranged between the isolating member 51 and a step portion 50b formed on the inner wall of the pressure relaxation chamber 50. One end of the spring 52 is fixed to the step portion 50b, and the other end is fixed to the isolating member 51. The length of the spring 52 is set such that, when the spring 52 is in a neutral state, the isolating member 51 is located at an end of the pressure relaxation chamber 50 that corresponds to the accommodation chamber 42.

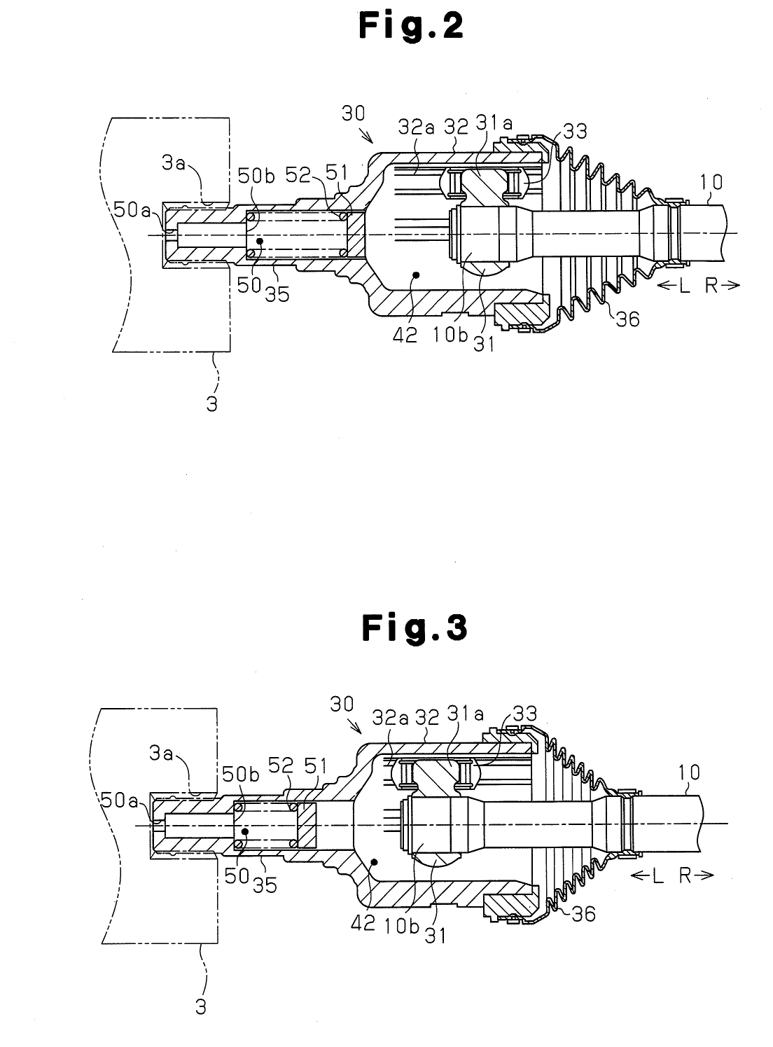

The method for installing the drive shaft according to the present embodiment to a vehicle will now be described with reference to FIGS. 2 and 3.

When assembling the outer ring 32 of the sliding type tripod constant velocity joint 30 with the differential gear 3, that is, when inserting the rod portion 35 of the outer ring 32 into the attachment hole 3a of the differential gear 3, the boot 36 is in the neutral state and the internal pressure of the accommodation chamber 42 is equal to the internal pressure of the pressure relaxation chamber 50. Thus, as shown in FIG. 2, the spring 52 is in a neutral state, and the isolating member 51 is located at an end of the pressure relaxation chamber 50 that corresponds to the accommodation chamber 42.

When assembling the outer ring 22 of the Birfield type constant velocity joint 20 with the hub 2, if the shaft member 10 is slid from the state shown in FIG. 2 in the outer ring 32 along a direction represented by arrow L in FIG. 2, the boot 36 is compressed as shown in FIG. 3, and the internal pressure of the accommodation chamber 42 becomes higher than the internal pressure of the pressure relaxation chamber 50. The pressure difference between the accommodation chamber 42 and the pressure relaxation chamber 50 compresses the spring 52 and displaces the isolating member 51 toward the pressure relaxation chamber 50. As a result, the volume of the accommodation chamber 42 is increased while the volume of the pressure relaxation chamber 50 is decreased. As the volume of the pressure relaxation chamber 50 is decreased, part of the air in the pressure relaxation chamber 50 is discharged to the inside of the differential gear 3 through the communication hole 50a, so that the pressure in the pressure relaxation chamber 50 is maintained to a substantially constant pressure (atmospheric pressure).

When the shaft member 10 is slid from the state shown in FIG. 3 along a direction represented by arrow R in FIG. 3 so that the rod portion 25 of the outer ring 22 into the attachment hole 2a of the hub 2, the boot 36 is expanded as shown in FIG. 2. That is, the boot 36 is returned to the neutral state, and the internal pressure of the accommodation chamber 42 becomes lower than the internal pressure of the pressure relaxation chamber 50. The pressure difference between the accommodation chamber 42 and the pressure relaxation chamber 50 and the urging force of the spring 52 displace the isolating member 51 toward the accommodation chamber 42. As a result, the volume of the accommodation chamber 42 is decreased while the volume of the pressure relaxation chamber 50 is increased. As the volume of the pressure relaxation chamber 50 is increased, air in the differential gear 3 is drawn into the pressure relaxation chamber 50 through the communication hole 50a, so that the pressure in the pressure relaxation chamber 50 is maintained to a substantially constant pressure (atmospheric pressure).

The first embodiment described above has the following advantages.

(1) At the time of installation of the drive shaft, when the shaft member 10 is slid in the outer ring 22 of the sliding type tripod constant velocity joint 30 to compress the boot 36, the isolating member 51 is displaced toward the pressure relaxation chamber 50 so that the volume of the accommodation chamber 42 is increased. This relaxes pressure increase in the accommodation chamber 42. Therefore, even if a resin material is used for the boot to increase the durability of the boot as in the present embodiment, the installation of the drive shaft is not made troublesome by a pressure increase in the accommodation chamber 42.

(2) When the isolating member 51 is displaced toward the pressure relaxation chamber 50 based on pressure increase in the accommodation chamber 42, the volume of the accommodation chamber 42 is increased. Accordingly, the grease filling the accommodation chamber 42 enters a part of the accommodation chamber 42 that corresponds to the increased volume. In this case, if the isolating member 51 is not smoothly displaced toward the accommodation chamber 42 based on pressure decrease in the accommodation chamber 42, the grease remains in the part of the accommodation chamber 42 corresponding to the increased volume. As a result, the amount of lubricant used for lubricating the components of the sliding type constant velocity joint is decreased, which can degrade the lubrication performance of the grease. In the present embodiment, the spring 52 is provided, which urges the isolating member 51 toward the accommodation chamber 42 when the isolating member 51 is displaced toward the pressure relaxation chamber 50. This promotes the displacement of the isolating member 51 when the isolating member 51 is displaced toward the accommodation chamber 42 as the pressure in the accommodation chamber 42 is lowered. As a result, the grease is prevented from remaining in the part of the accommodation chamber 42 corresponding to the increased volume. This prevents the lubricating performance of the grease from deteriorating due to such remaining grease.

(3) When the pressure in the accommodation chamber 42 is increased, the isolating member 51 is displaced toward the pressure relaxation chamber 50, thereby reducing the volume of the pressure relaxation chamber 50. Therefore, in the case, for example, where the pressure relaxation chamber 50 is a sealed space, an increase in volume of the accommodation chamber 42 raises the pressure in the pressure relaxation chamber 50. Accordingly, the resistance of the isolating member 51 against displacement is increased. In the present embodiment, the pressure relaxation chamber 50 communicates with the outside of the outer ring 32 through the communication hole 50a. Thus, when the isolating member 51 is displaced toward the pressure relaxation chamber 50, as the volume of the pressure relaxation chamber 50 is decreased, part of the air in the pressure relaxation chamber 50 is discharged to the inside of the differential gear 3 through the communication hole 50a, so that the pressure in the pressure relaxation chamber 50 is maintained to a substantially constant pressure (atmospheric pressure). Therefore, for example, compared to the case where the pressure relaxation chamber 50 is a sealed chamber, the resistance of the isolating member 51 against displacement is effectively prevented from being increased by an increase in the internal pressure of the pressure relaxation chamber 50 when the isolating member 51 is displaced toward the pressure relaxation chamber 50.

(4) The pressure relaxation chamber 50 is formed in the rod portion 35. This prevents the size of the outer ring 32 from being increased.

A second embodiment according to the present invention will now be described. The differences from the first embodiment will mainly be discussed.

The basic structure of a drive shaft according to the second embodiment is the same as that of the drive shaft according to the above described first embodiment. However, the second embodiment is different from the first embodiment in the structure for increasing the volume of the accommodation chamber 42 when the pressure of the accommodation chamber 42 increases.

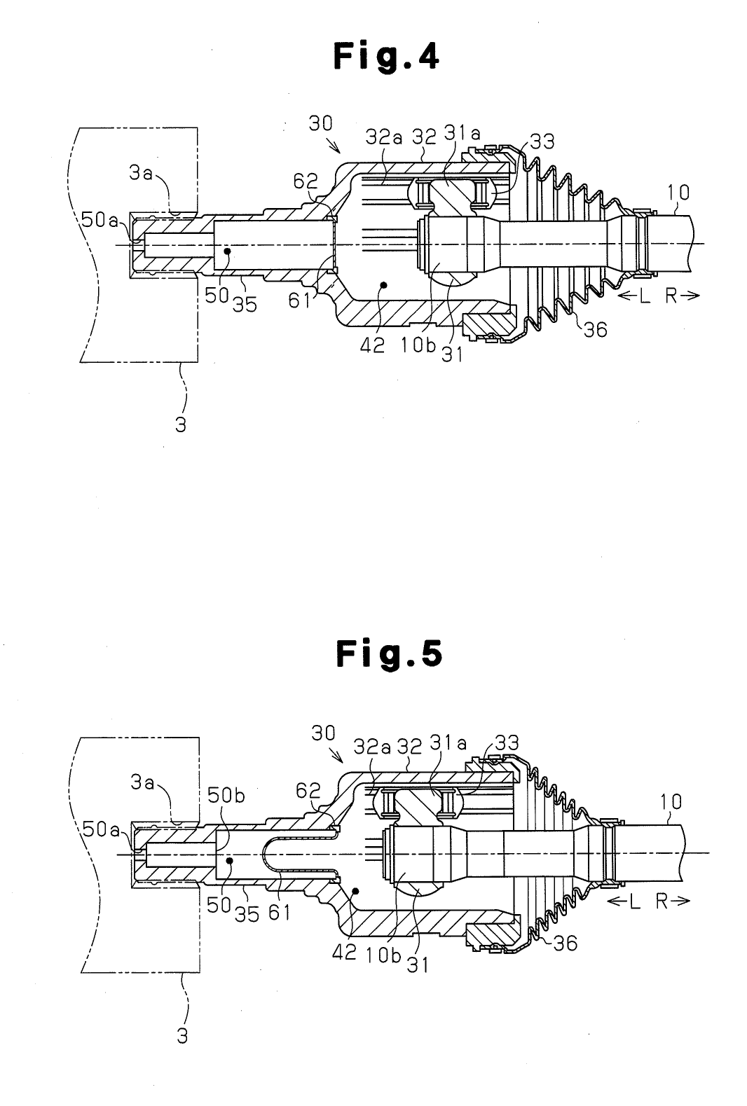

As shown in FIG. 4, an elastic film 61 made of a rubber sheet is attached to an end of the accommodation chamber 42 on the inner wall of the pressure relaxation chamber 50 by means of an attachment member 62. The elastic film 61 is attached to cover an opening of the pressure relaxation chamber 50 that faces the accommodation chamber 42 to isolate the accommodation chamber 42 and the pressure relaxation chamber 50 from each other. The size of the elastic film 61 is set such that, when the elastic film 61 is in a neutral state, the elastic film 61 is substantially flat.

When assembling the outer ring 32 of the sliding type tripod constant velocity joint 30 with the differential gear 3, that is, when inserting the rod portion 35 of the outer ring 32 into the attachment hole 3a of the differential gear 3, the elastic film 61 becomes substantially flat since the internal pressure of the accommodation chamber 42 is equal to the internal pressure of the pressure relaxation chamber 50.

Next, when assembling the outer ring 22 of the Birfield type constant velocity joint 20 with the hub 2, if the shaft member 10 is slid from the state shown in FIG. 4 in the outer ring 32 along a direction represented by arrow L in FIG. 4, the boot 36 is compressed as shown in FIG. 5, and the internal pressure of the accommodation chamber 42 becomes higher than the internal pressure of the pressure relaxation chamber 50. The pressure difference between the accommodation chamber 42 and the pressure relaxation chamber 50 elastically deforms the elastic film 61 toward the pressure relaxation chamber 50. As a result, the volume of the accommodation chamber 42 is increased while the volume of the pressure relaxation chamber 50 is decreased. As the volume of the pressure relaxation chamber 50 is decreased, part of the air in the pressure relaxation chamber 50 is discharged to the inside of the differential gear 3 through the communication hole 50a, so that the pressure in the pressure relaxation chamber 50 is maintained to a substantially constant pressure (atmospheric pressure).

When the shaft member 10 is slid from the state shown in FIG. 5 along a direction represented by arrow R in FIG. 5 so that the rod portion 25 of the outer ring 22 into the attachment hole 2a of the hub 2, the boot 36 is expanded as shown in FIG. 2. That is, the boot 36 is returned to the neutral state, and the internal pressure of the accommodation chamber 42 becomes lower than the internal pressure of the pressure relaxation chamber 50. The pressure difference between the accommodation chamber 42 and the pressure relaxation chamber 50 and the elastic force of the elastic film 61 elastically deform the elastic film 61 toward the accommodation chamber 42. As a result, the volume of the accommodation chamber 42 is decreased while the volume of the pressure relaxation chamber 50 is increased. As the volume of the pressure relaxation chamber 50 is increased, air in the differential gear 3 is drawn into the pressure relaxation chamber 50 through the communication hole 50a, so that the pressure in the pressure relaxation chamber 50 is maintained to a substantially constant pressure (atmospheric pressure).

In addition to the advantage (4) of the first embodiment, the second embodiment has the following advantages.

(5) At the time of installation of the drive shaft, when the shaft member 10 is slid in the outer ring 22 of the sliding type tripod constant velocity joint 30 to compress the boot 36, the elastic film 61 is elastically deformed toward the pressure relaxation chamber 50 so that the volume of the accommodation chamber 42 is increased. This relaxes pressure increase in the accommodation chamber 42. Therefore, even if a resin material is used for the boot to increase the durability of the boot as in the present embodiment, the installation of the drive shaft is not made troublesome by a pressure increase in the accommodation chamber 42.

(6) When the pressure in the accommodation chamber 42 is increased, the elastic film 61 is elastically deformed toward the pressure relaxation chamber 50, thereby reducing the volume of the pressure relaxation chamber 50. Therefore, for example, in the case where the pressure relaxation chamber 50 is a sealed space, an increase in volume of the accommodation chamber 42 raises the pressure in the pressure relaxation chamber 50. Accordingly, the resistance of the elastic film 61 against elastic deformation is increased. In the present embodiment, the pressure relaxation chamber 50 communicates with the outside of the outer ring 32 through the communication hole 50a. Thus, when the elastic film 61 is displaced toward the pressure relaxation chamber 50, as the volume of the pressure relaxation chamber 50 is decreased, part of the air in the pressure relaxation chamber 50 is discharged to the inside of the differential gear 3 through the communication hole 50a, so that the pressure in the pressure relaxation chamber 50 is maintained to a substantially constant pressure (atmospheric pressure). Therefore, for example, compared to the case where the pressure relaxation chamber 50 is a sealed chamber, the resistance of the elastic film 61 against elastic deformation is effectively prevented from being increased by an increase in the internal pressure of the pressure relaxation chamber 50 when the elastic film 61 is elastically deformed toward the pressure relaxation chamber 50.

It should be apparent to those skilled in the art that the present invention may be embodied in many other specific forms without departing from the spirit or scope of the invention. Particularly, it should be understood that the invention may be embodied in the following forms.

In the first embodiment, the spring 52, which urges the isolating member 51 toward the accommodation chamber 42, is provided between the isolating member 51 and the step portion 50b formed on the inner wall of the pressure relaxation chamber 50. For example, if the resistance generated in the grease against displacement of the isolating member 51 is negligible, the spring 52 may be omitted.

In the illustrated embodiments, the pressure relaxation chamber 50 is formed in the rod portion 35 of the outer ring 32. For example, if the structure of the outer ring 32 does not allow the pressure relaxation chamber 50 to be formed in the main body of the outer ring 32, a pressure relaxation chamber may be defined by arranging a partition member in the accommodation chamber 42.

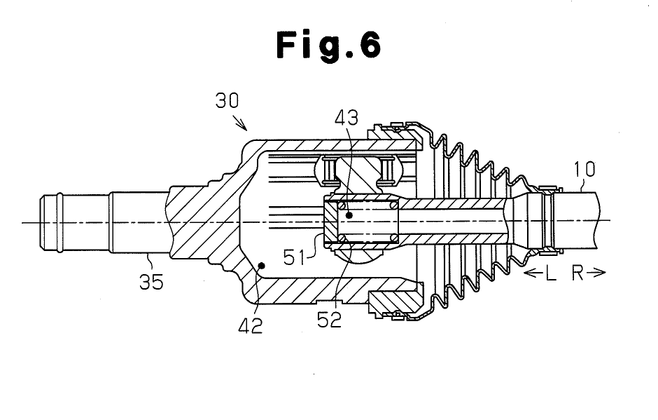

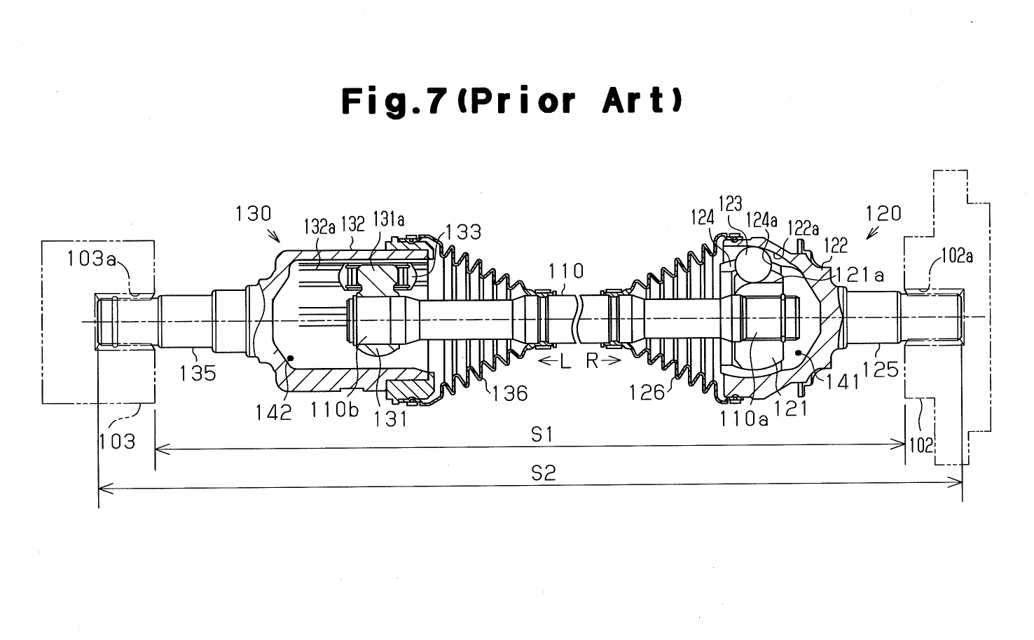

Also, for example, if a hollow shaft member 10 as shown in FIG. 6 is used for reducing the weight, an isolating member 51 or an elastic film 61 may be provided at an end of a space 43 in the shaft member 10 that corresponds to the accommodation chamber 42. This structure eliminates the necessity for forming a separate pressure relaxation chamber only to facilitate the installation of the drive shaft, thereby simplifying the structure of the drive shaft.

In the above embodiments, the present invention is applied to the drive shaft having the boot 36 made of a resin material. However, the present invention may be applied without changing the basic structure to a drive shaft having a boot made of, for example, rubber.

In the above embodiments, the present invention is applied to the drive shaft in which the shaft member 10 is coupled to the hub 2 of the drive wheel through the Birfield type constant velocity joint 20, and to the differential gear 3 through the sliding type tripod constant velocity joint 30. In contrast, the present invention may be applied without changing the basic structure to a drive shaft in which the shaft member 10 is coupled to the differential gear 3 through the Birfield type constant velocity joint 20, and to the hub 2 of the drive wheel through the sliding type tripod constant velocity joint 30.

In the above embodiments, the pressure relaxation chamber 50 communicates with the outside of the outer ring 32 through the communication hole 50a. However, for example, in the case where the rod portion 35 of the outer ring 32 needs to have a high rigidity and no communication hole can be formed in the rod portion 35, such a communication hole does not need to be formed. Even in this structure, since the isolating member 51 (the elastic film 61) is displaced (elastically deformed) toward the pressure relaxation chamber 50 based on an increase in pressure of the accommodation chamber 42, the installation of the drive shaft is not made troublesome by a pressure increase in the accommodation chamber 42. In this case, if the isolating member 51 is displaced toward the pressure relaxation chamber 50, the pressure of the air in the pressure relaxation chamber 50 is raised so that the air functions as an air spring. The spring 52 therefore may be omitted.

In the above embodiments, the present invention is applied to the drive shafts having the sliding type tripod constant velocity joint 30. The present invention is not limited to this, but may be applied without changing the basic structure to any drive shaft having different types of constant velocity joint, such as a double offset constant velocity joint that is attached to the shaft member 10 and can be displaced in the axial direction relative to the shaft member 10.

The present examples and embodiments are to be considered as illustrative and not restrictive and the invention is not to be limited to the details given herein, but may be modified within the scope and equivalence of the appended claims.

1. A vehicle drive shaft, comprising:
a sliding type constant velocity joint having an outer ring, in which an accommodation chamber is formed, and an inner ring accommodated in the accommodation chamber, wherein the inner ring is permitted to be displaced in the axial direction relative to the outer ring, while being prevented from rotating relative to the outer ring;
a shaft member having an end portion to which the inner ring is attached;
a boot having one end fastened to the shaft member and another end fastened to an outer circumference of the outer ring, wherein the boot seals the accommodation chamber and can be expanded and contracted in accordance with relative displacement of the outer ring and the shaft member; and
an isolating member that forms a pressure relaxation chamber in the outer ring so as to isolate the pressure relaxation chamber and the accommodation chamber from each other, wherein, when a pressure in the accommodation chamber is raised, the isolating member is displaced toward the pressure relaxation chamber by a pressure difference between the accommodation chamber and the pressure relaxation chamber, thereby increasing the volume of the accommodation chamber, and wherein, when the pressure in the accommodation chamber is lowered, the isolating member is displaced toward the accommodation chamber by the pressure difference, thereby decreasing the volume of the accommodation chamber.

2. The drive shaft according to claim 1, further comprising an urging member that urges the isolating member toward the accommodation chamber.

3. The drive shaft according to claim 1, wherein the pressure relaxation chamber communicates with the outside of the outer ring.

4. The drive shaft according to claim 1, wherein the boot is made of a resin material.

5. The drive shaft according to claim 1, wherein the outer ring has a rod portion that is coupled to a drive system or a drive wheel of the vehicle, and wherein the pressure relaxation chamber is formed in the rod portion of the outer ring.

6. A vehicle drive shaft, comprising:
a sliding type constant velocity joint having an outer ring, in which an accommodation chamber is formed, and an inner ring accommodated in the accommodation chamber, wherein the inner ring is permitted to be displaced in the axial direction relative to the outer ring, while being prevented from rotating relative to the outer ring;
a shaft member having an end portion to which the inner ring is attached;
a boot having one end fastened to the shaft member and another end fastened to an outer circumference of the outer ring, wherein the boot seals the accommodation chamber and can be expanded and contracted in accordance with relative displacement of the outer ring and the shaft member; and
an elastic film that forms a pressure relaxation chamber in the outer ring so as to isolate the pressure relaxation chamber and the accommodation chamber from each other, wherein, when a pressure in the accommodation chamber is raised, the elastic film is elastically deformed toward the pressure relaxation chamber by a pressure difference between the accommodation chamber and the pressure relaxation chamber, thereby increasing the volume of the accommodation chamber, and wherein, when the pressure in the accommodation chamber is lowered, the elastic film is elastically deformed toward the accommodation chamber by the pressure difference, thereby decreasing the volume of the accommodation chamber.

7. The drive shaft according to claim 6, wherein the pressure relaxation chamber communicates with the outside of the outer ring.

8. The drive shaft according to claim 6, wherein the boot is made of a resin material.

9. The drive shaft according to claim 6, wherein the outer ring has a rod portion that is coupled to a drive system or a drive wheel of the vehicle, and wherein the pressure relaxation chamber is formed in the rod portion of the outer ring.
